(19) United States
(12) Patent Application Publication
(10) Pub. No.: US 2024/0171658 A1
(43) Pub. Date: May 23, 2024

(54) WIRELESS COMMUNICATION SYSTEM, CONTROLLER, WIRELESS BASE STATION, AND DATA PACKET TRANSFER METHOD

(71) Applicant: MURATA MACHINERY, LTD., Kyoto-shi, Kyoto (JP)

(72) Inventors: Yoshifumi TANIMOTO, Kyoto-shi (JP); Yasuki UEDA, Kyoto-shi (JP)

(21) Appl. No.: 18/282,814

(22) PCT Filed: Feb. 17, 2022
(86) PCT No.: PCT/JP2022/006399

§ 371 Date: Sep. 19, 2023

(30) Foreign Application Priority Data
Mar. 24, 2021 (JP) 2021-050331

(51) Int. Cl. H04L 69/08

(52) U.S. Cl. CPC H04L 69/08

(57) ABSTRACT

A wireless communication system includes a transfer unit processor. In a case where a destination of a data packet sent from a server is a first wireless communication terminal, the transfer unit processor converts the data packet into a predetermined data frame and transfers the predetermined data frame to the first wireless communication terminal. On the other hand, in a case where the destination of the data packet sent from the server is a second wireless communication terminal, the transfer processor transfers the data packet to the second wireless communication terminal without converting the data packet into the data frame.

### BACKGROUND OF THE INVENTION

### 1. Field of the Invention

The present invention relates to a wireless communication system, and in particular to a system including a plurality of wireless communication terminals, a wireless base station wirelessly connected to the wireless communication terminals, and a controller configured or programmed to communicate to the wireless communication terminals via the wireless base station and being communicably connected to another communication system via a predetermined network.

### 2. Description of the Related Art

In a typical wireless communication system, in order to enable versatile wireless communication devices to communicate, communication packets are transmitted and received, which have a format that is compliant with a versatile communication protocol and are transferred on the Ethernet (registered trademark). JP-A-2004-289659 discloses a technique in which only a destination and a source address are set in the header of the packet so as to communicate with a mobile IP terminal included in an external network, while information necessary for Mobile IPv6 communication is set in the header of the packet so as to communicate with a correspondent node.

### SUMMARY OF THE INVENTION

The conventional invention as disclosed in JP-A-2004-289659 performs data packet conversion uniformly on all the mobile IP terminals included in the external network, and therefore has a problem of processing load for performing the conversion.

Preferred embodiments of the present invention reduce processing load in wireless communication systems.

Hereinafter, a plurality of preferred embodiments are described. These preferred embodiments can be arbitrarily combined or modified as necessary or desired.

A wireless communication system according to one aspect of a preferred embodiment of the present invention includes a plurality of wireless communication terminals, a wireless base station that is wirelessly connected to the wireless communication terminals, and a controller configured or programmed to communicate to the wireless communication terminals via the wireless base station and communicably connected to another communication system via a predetermined network. The wireless communication system includes a transfer processor configured or programmed to, in a case where a destination of a data packet sent from the another communication system is a specific wireless communication terminal among the plurality of wireless communication terminals, convert the data packet into a predetermined data frame and transfer the predetermined data frame to the wireless communication terminal. On the other hand, if the destination of the data packet sent from the another communication system is a wireless communication terminal other than the specific wireless communication terminal among the plurality of wireless communication terminals, the transfer processor is configured or programmed to transfer the data packet to the wireless communication terminal without converting the data packet into the predetermined data frame. The wireless communication system further includes a plurality of the specific wireless communication terminals. In a case where a destination of a predetermined data frame sent from one of the plurality of specific wireless communication terminals is another of the plurality of specific wireless communication terminals, the transfer processor is configured or programmed to transfer the predetermined data frame to the wireless communication terminal without converting the predetermined data frame into the data packet.

In this wireless communication system, the data packet is not converted if the destination of the data packet sent from the another communication system is a wireless communication terminal other than the specific wireless communication terminal among the plurality of wireless communication terminals, and hence, the processing load required to perform the data packet conversion is reduced. In addition, for the specific wireless communication terminal, a data packet size can be reduced by the conversion, and hence, the communication load in the wireless communication system can be reduced.

In a case where a destination of a predetermined data frame sent from a specific wireless communication terminal is another communication system, the transfer processor may convert the predetermined data frame into the data packet and transfer the same to the another communication system. In this wireless communication system, in upstream communication from the specific wireless communication terminal to the another communication system, the transfer processor converts the predetermined data frame into the data packet, and hence it is possible to realize wireless communication using a communication protocol that is compliant with the another communication system.

The wireless communication system may include a plurality of the specific wireless communication terminals. In a case where a destination of a predetermined data frame sent from the specific wireless communication terminal is another of the specific wireless communication terminals, the transfer processor may transfer the predetermined data frame to the wireless communication terminal without converting the same into the data packet. In this wireless communication system, a communication load for communication between specific wireless communication terminals can be reduced.

The transfer processor may be included in the controller. In this wireless communication system, the transfer processor of the controller is configured or programmed to determine the destination of the predetermined data packet, and convert the data packet into the predetermined data frame so as to transfer the same. As the controller can perform central control of the data conversion, it is possible to support various changes, such as change in wireless communication setting.

The transfer processor may be included in the wireless base station. In this wireless communication system, the transfer processor of the wireless base station is configured or programmed to determine the destination of the data packet, and convert the data packet into the predetermined data frame so as to transfer the same. As the plurality of wireless base stations can perform the data conversion, a processing load can be distributed.

The data frame may be a data frame that includes at least a destination and a transmission data portion. The data packet may be a communication packet of a versatile communication protocol format that is transferred on the Ethernet.

The wireless communication terminal may be mounted in a mobile body. In this wireless communication system, a communication load of a moving wireless communication terminal is reduced.

A controller according to another aspect of a preferred embodiment of the present invention is a controller in a wireless communication system including a plurality of wireless communication terminals, and a wireless base station wirelessly connected to the wireless communication terminals. The controller is configured or programmed to communicate to the wireless communication terminals via the wireless base station and is communicably connected to another communication system via a predetermined network. The controller includes a transfer processor that is configured or programmed to, in a case where a destination of a data packet sent from the another communication system is a specific wireless communication terminal among the plurality of wireless communication terminals, convert the data packet into a predetermined data frame and transfer the predetermined data frame to the wireless base station that is wirelessly connected to the wireless communication terminal. On the other hand, in a case where the destination of the data packet sent from the another communication system is a wireless communication terminal other than the specific wireless communication terminal among the plurality of wireless communication terminals, the transfer processor is configured or programmed to transfer the data packet to the wireless base station that is wirelessly connected to the wireless communication terminal, without converting the data packet into the predetermined data frame. The wireless communication system further includes a plurality of the specific wireless communication terminals. In a case where a destination of a predetermined data frame sent from one of the plurality of specific wireless communication terminals is another of the plurality of specific wireless communication terminals, the transfer processor is configured or programmed to transfer the predetermined data frame to the wireless communication terminal without converting the predetermined data frame into the data packet.

A wireless base station according to still another aspect of a preferred embodiment of the present invention is a wireless base station in a wireless communication system including a plurality of wireless communication terminals and a controller communicably connected to another communication system via a predetermined network. The wireless base station is wirelessly connected to the wireless communication terminals and is connected to the controller. The wireless base station includes a transfer processor that is configured or programmed to, in a case where a destination of a data packet sent from the another communication system via the controller is a specific wireless communication terminal among the plurality of wireless communication terminals, convert the data packet into a predetermined data frame and transfer the predetermined data frame to the wireless communication terminal. On the other hand, if the destination of the data packet sent from the another communication system via the controller is a wireless communication terminal other than the specific wireless communication terminal among the plurality of wireless communication terminals, the transfer processor is configured or programmed to transfer the data packet to the wireless communication terminal without converting the data packet into the predetermined data frame. The wireless communication system further includes a plurality of the specific wireless communication terminals. In a case where a destination of a predetermined data frame sent from one of the plurality of specific wireless communication terminals is another of the plurality of specific wireless communication terminals, the transfer processor is configured or programmed to transfer the predetermined data frame to the wireless communication terminal without converting the predetermined data frame into the data packet.

A data packet transfer method according to another aspect of a preferred embodiment of the present invention is a method in a wireless communication system including a plurality of wireless communication terminals, a wireless base station that is wirelessly connected to the wireless communication terminals, and a controller that is configured or programmed to communicate to the wireless communication terminals via the wireless base station and is communicably connected to another communication system via a predetermined network. The data packet transfer method includes determining whether or not destination of a data packet sent from the another communication system is a specific wireless communication terminal among the plurality of wireless communication terminals, converting the data packet into a predetermined data frame in a case where the destination is the specific wireless communication terminal, while not converting the data packet in a case where the destination is a wireless communication terminal other than the specific wireless communication terminal, and transferring the predetermined data frame or the data packet to the wireless communication terminal. The wireless communication system further includes a plurality of the specific wireless communication terminals. In a case where a destination of a predetermined data frame sent from one of the plurality of specific wireless communication terminals is another of the plurality of specific wireless communication terminals, the transfer processor is configured or programmed to transfer the predetermined data frame to the wireless communication terminal without converting the predetermined data frame into the data packet.

In wireless communication systems and methods according to preferred embodiments of the present invention, processing load is reduced.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram illustrating an overall structure of a wireless communication system according to a first preferred embodiment (upstream communication and downstream communication) of the present invention.

FIG. 2 is a schematic diagram illustrating an overall structure of the wireless communication system according to the first preferred embodiment (communication between wireless communication terminals) of the present invention.

FIG. 3 is a block diagram illustrating a control structure of a wireless base station and a controller.

FIG. 4 is a conversion table of IP addresses and wireless communication terminal identifiers.

FIG. 5 is a schematic diagram illustrating data conversion in the controller (downstream communication).

FIG. 6 is a schematic diagram illustrating data conversion in the controller (downstream communication).

FIG. 7 is a schematic diagram illustrating data conversion in the controller (upstream communication).

FIG. 8 is a flowchart illustrating data conversion control operation by the controller.

FIG. 9 is a schematic diagram illustrating an overall structure of the wireless communication system according to a second preferred embodiment (upstream communication and downstream communication) of the present invention.

FIG. 10 is a block diagram illustrating a control structure of the wireless base station and the controller.

FIG. 11 is a schematic diagram illustrating data conversion in the wireless base station (downstream communication).

FIG. 12 is a schematic diagram illustrating data conversion in the wireless base station (downstream communication).

FIG. 13 is a schematic diagram illustrating data conversion in the wireless base station (upstream communication).

### DETAILED DESCRIPTION OF THE PREFERRED EMBODIMENTS

### 1. First Preferred Embodiment

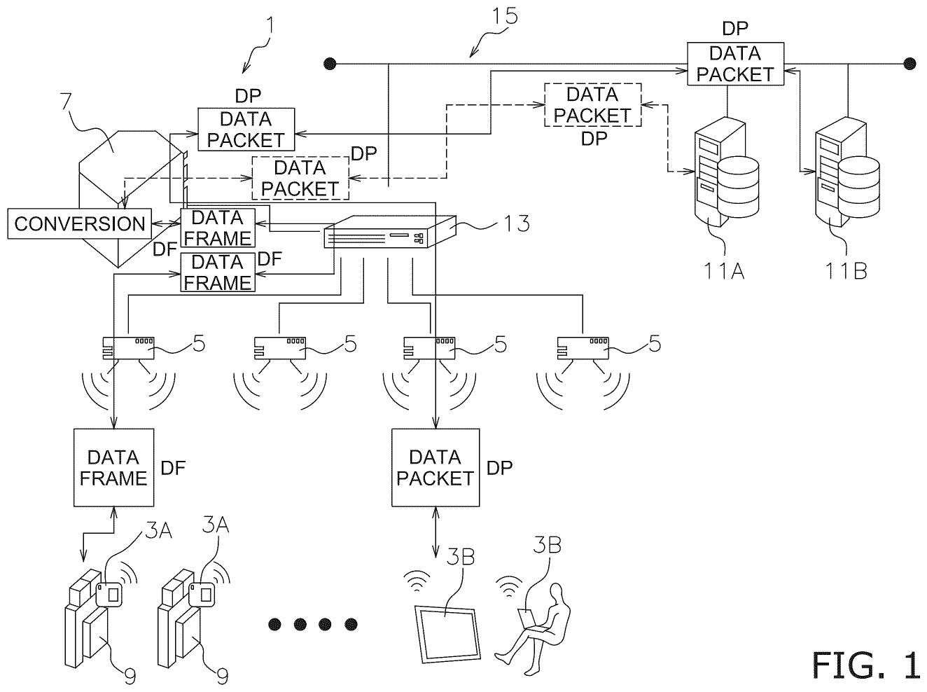

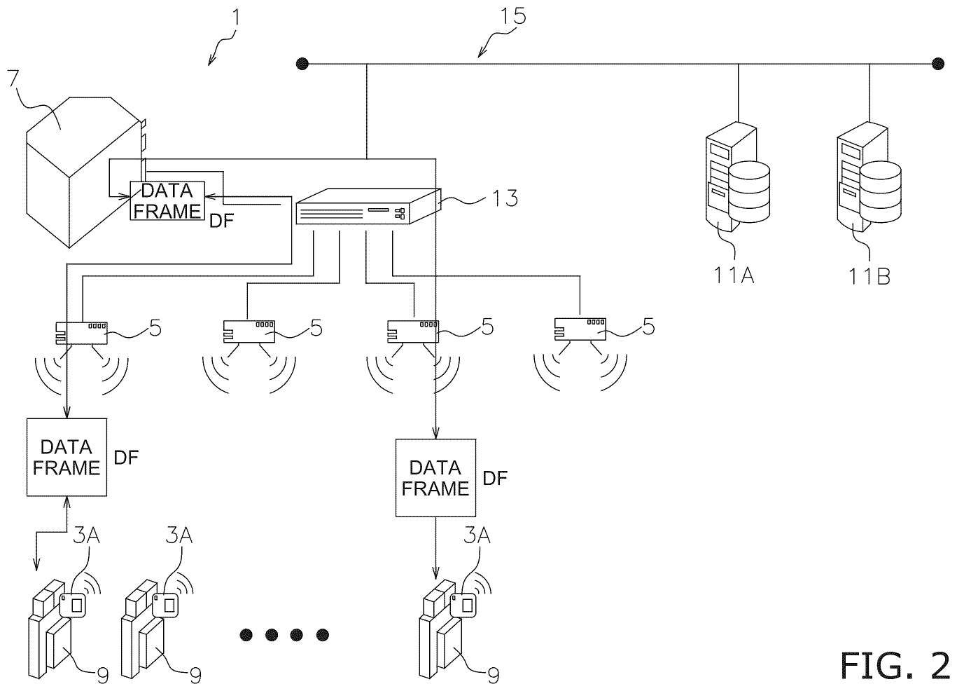

With reference to FIGS. 1 and 2, a wireless communication system 1 according to a first preferred embodiment of the present invention is described. FIGS. 1 and 2 are schematic diagrams illustrating overall structures of the wireless communication system according to the first preferred embodiment of the present invention. The wireless communication system 1 includes a plurality of first wireless communication terminals 3A, a plurality of second wireless communication terminals 3B, a plurality of wireless base stations 5, and a controller 7.

The first wireless communication terminals 3A and the second wireless communication terminals 3B are each a local 5G or Wi-Fi (registered trademark) communication unit, for example. Note that IP addresses of the first wireless communication terminals 3A and the second wireless communication terminals 3B are each a fixed address. However, information that identifies the first wireless communication terminal 3A or the second wireless communication terminal 3B is not limited to the IP address. In this case, the information that identifies the first wireless communication terminal 3A or the second wireless communication terminal 3B has a format that can be used in a communication protocol used in the wireless communication system 1.

The first wireless communication terminals 3A are a group of wireless communication terminals installed in a factory, and are mounted respectively in a plurality of conveyance carriages 9 (an example of mobile bodies) in the factory, for example. When the conveyance carriage 9 moves, the first wireless communication terminal 3A may exit a communication range of the wireless base station 5. In that case, it enters a communication range of another wireless base station 5 and continues the communication.

The second wireless communication terminals 3B are another group of wireless communication terminals installed in the factory, which are different from the first wireless communication terminals 3A, and are mounted respectively in computers for work other than the conveyance carriages 9 (such as desktop personal computers, tablet computers, or mobile phones). In this preferred embodiment, the number of the first wireless communication terminals 3A is larger than the number of the second wireless communication terminals 3B.

In this preferred embodiment, the first wireless communication terminal 3A is an example of a “specific wireless communication terminal”, and the second wireless communication terminal 3B is an example of a “wireless communication terminal other than the specific wireless communication terminal”.

The wireless communication system 1 includes a portion of a conveyance system including the plurality of conveyance carriages 9. In the conveyance system, the external server 11A, 11B is an upper system and has information about the entire conveyance carriage 9. For instance, using the wireless communication system 1, a package conveyance instruction is sent from the server 11A, 11B to the plurality of conveyance carriages 9, while information about a state, a change, or a position of the conveyance carriage 9 is sent from the conveyance carriage 9 to the servers 11A and 11B. Note that the server 11A is described below as a typical example.

In the wireless communication system 1, a data packet DP or a data frame DF is transmitted and received between the devices as described later. As an example, the data packet DP is a communication packet of a versatile communication protocol format that is transferred on the Ethernet (registered trademark).

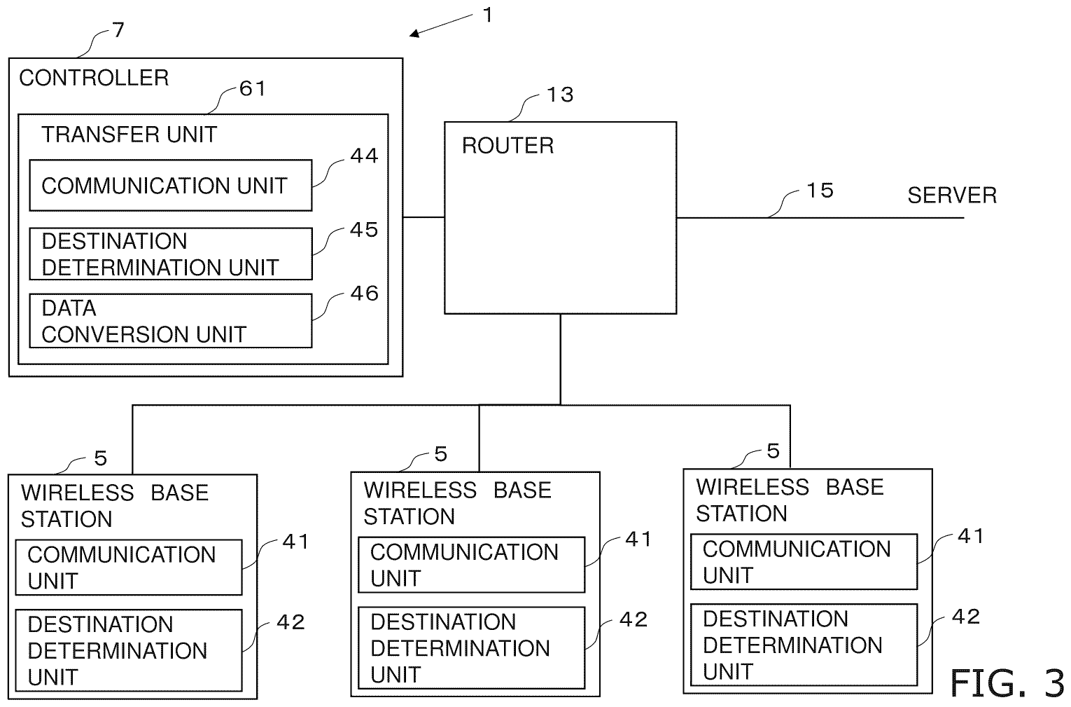

With reference to FIG. 3, a control structure of the wireless base station 5 and the controller 7 is described. FIG. 3 is a block diagram illustrating a control structure of the wireless base station and the controller. The wireless base station 5 includes a communication unit 41 and a destination determination unit 42. The destination determination unit 42 is a function of a CPU that operates according to a program. The CPU may be a single processor or a plurality of independent processors for individual controls. A portion or an entirety of functions of the CPU may be realized by a program that can be executed by a computer system including the control unit. Other than that, a portion of functions of the control unit may be a custom IC. Note that the above description can also be applied to other CPUs.

The wireless base station 5 is wirelessly connected to the plurality of first wireless communication terminals 3A and second wireless communication terminals 3B. The wireless base station 5 informs the controller 7 that the first wireless communication terminal 3A or the second wireless communication terminal 3B has entered or exited the communication range of the station.

The controller 7 is a computer system including a CPU, a RAM, a ROM, and the like, and controls the entire wireless communication system 1. The controller 7 communicates to the first wireless communication terminal 3A or the second wireless communication terminal 3B via the wireless base station 5. A router 13 is disposed between the controller 7 and the plurality of wireless base stations 5. Note that in this preferred embodiment, the controller 7 and the wireless base station 5 are wired and connected to each other.

The controller 7 is communicably connected to the server 11A, 11B (an example of another communication system) via a wired or wireless network 15 (an example of a predetermined network). As illustrated in FIG. 3, the controller 7 includes a communication unit 44, a destination determination unit 45, and a data conversion unit 46 (described later).

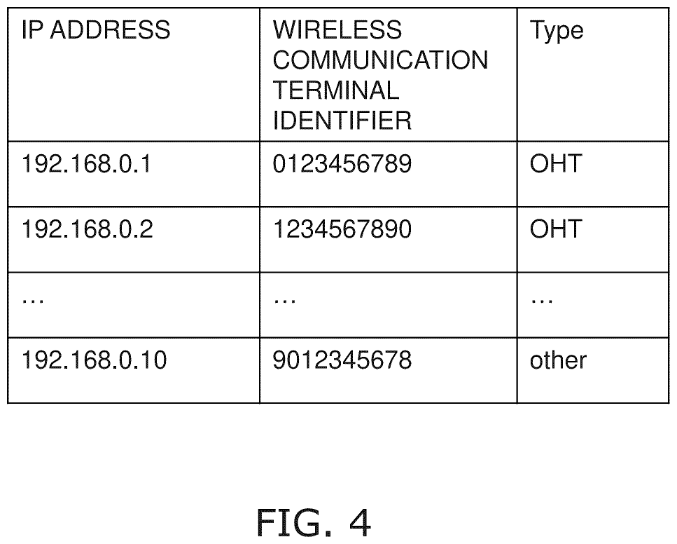

The controller 7 knows IP addresses of the first wireless communication terminals 3A and the second wireless communication terminals 3B, and knows which wireless base station 5 is connected to each of the first wireless communication terminals 3A and the second wireless communication terminals 3B. Specifically, as illustrated in FIG. 4, the controller 7 has a table in which the IP addresses and wireless communication terminal identifiers are associated with each other, and determines the wireless communication terminal identifier from the IP address. FIG. 4 illustrates an example of the table in which the IP addresses and the wireless communication terminal identifiers are associated with each other.

As illustrated in FIG. 3, the communication unit 44, the destination determination unit 45 and the data conversion unit 46 realize a transfer unit 61 (transfer processor) as a function that the CPU performs according to a program. The destination determination unit 45 determines a destination of the data packet DP. Based on a result of the determination by the destination determination unit 45, the communication unit 44 transfers the data packet DP as it is, or transfers a predetermined data frame DF (converted packet) after the data packet DP is converted into the data frame DF by the data conversion unit 46 (described later). In this way, the controller 7 can perform central control of transmission and conversion, and hence it is easy to support various modifications.

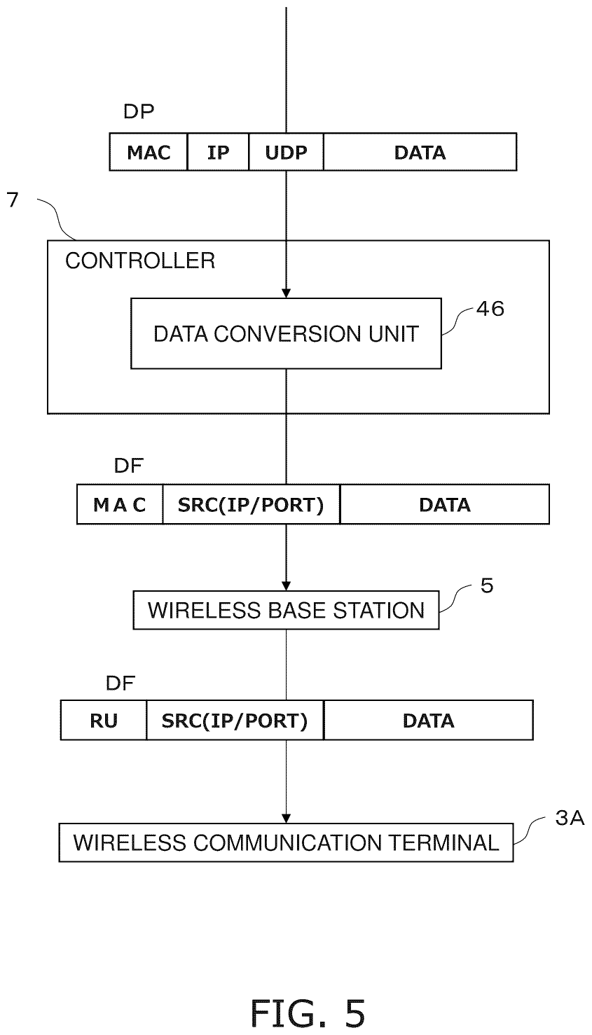

As an example, the data frame DF includes at least a header portion and a data portion. Specifically, the data portion includes, for example, control data used to control the conveyance carriage 9, such as a conveyance command including information of source and destination of a package to be conveyed by the conveyance carriage 9, or a movement command including information of movement destination of the conveyance carriage 9. The data portion corresponds to “DATA” of data frame DF shown in FIG. 5 or the like.

The header portion includes information about a source or destination of data contained in the data frame DF. Specifically, the header portion of the data frame DF, whose destination is the wireless communication terminal, includes RU and SRC (IP/PORT). RU is a header called a wireless header. SRC (IP/PORT) is information indicating the IP address (four bytes) of the source and its port number. On the other hand, the header portion of the data frame DF, whose source is the wireless communication terminal, includes RU and DST (IP/PORT). DST (IP/PORT) is information indicating the IP address of the destination and its port number.

The data frame DF is generated by replacing the header portion (MAC/IP/UDP) of the data packet DP with RU/SRC (IP/PORT) or RU/DST (IP/PORT). The data portion has a size of approximately 64 bytes, for example, while the header portion of the data packet DP, which is the communication packet of the versatile communication protocol format, has a size of approximately a few tens of bytes. On the other hand, the header portion of the data frame DF has a size that is smaller than that of the header portion of the data packet DP. Therefore, by converting the data packet DP into the data frame DF, a packet size that is used for communication in the wireless communication terminal can be largely reduced.

Note that the header portion of the data frame DF may or may not include information about the source. In addition, the header portion of the data frame DF may be omitted. In this way, the packet size can be reduced more largely.

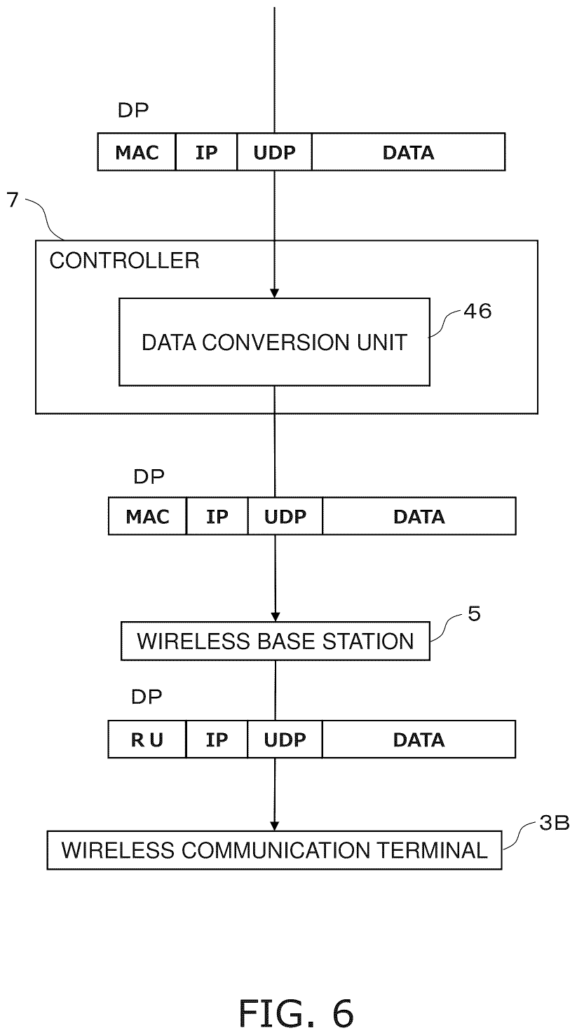

With reference to FIGS. 5 and 6, data conversion in the controller 7 is described. FIGS. 5 and 6 are schematic diagrams illustrating data conversion in the controller. FIGS. 5 and 6 illustrate communication in which the first wireless communication terminal 3A and the second wireless communication terminal 3B are respectively destinations. The communication in which the wireless communication terminal is a destination is referred to as “downstream communication”. In the downstream communication, the data packet DP sent from the server 11A is conventionally transmitted to the first wireless communication terminal 3A or the second wireless communication terminal 3B via the controller 7, the router 13, and the wireless base station 5. In this preferred embodiment, the data packet DP is converted into the data frame DF in some cases and is not converted in other cases, as described below.

As a description in the case where the conversion is performed, in a case where the destination of the data packet DP sent from the server 11A is one of the plurality of first wireless communication terminals 3A, the data conversion unit 46 of the controller 7 converts the data packet DP into the predetermined data frame DF and transfers the same to the first wireless communication terminal 3A of the destination. Specifically, the predetermined data frame DF is transmitted to the first wireless communication terminal 3A via the router 13 and the wireless base station 5.

As illustrated in FIG. 5, the data conversion unit 46 converts the data packet DP into the data frame DF. Specifically, the header portion (MAC/IP/UDP) of the data packet DP is replaced with RU/SRC (IP/PORT) in the data frame DF. More specifically, the data conversion unit 46 grasps the source of the data packet DP based on information included in the header portion (MAC/IP/UDP) of the data packet DP, and generates SRC (IP/PORT) of the data frame DF based on information about the grasped source. After that, the data conversion unit 46 replaces IP/UDP of the data packet DP with SRC (IP/PORT). Furthermore, the wireless base station 5 that has received the data frame DF replaces the MAC header of the data frame DF received from the controller 7 with the RU header.

As a description in the case where the conversion is not performed, if the destination of the data packet DP sent from the server 11A is one of the plurality of second wireless communication terminals 3B, the data conversion unit 46 of the controller 7 does not convert the data packet DP as illustrated in FIG. 6. As a result, the data packet DP is transmitted to the second wireless communication terminal 3B of the destination via the router 13 and the wireless base station 5. Note that after the process in the controller 7, the MAC header of the data packet DP is replaced with the RU header in the wireless base station 5.

As illustrated in FIG. 6, in this preferred embodiment, if the destination of the data packet DP sent from the server 11A is the second wireless communication terminal 3B, the data packet DP is not converted. Therefore, the processing load of converting the data packet DP does not become extremely large as a whole. In other words, the data conversion is not always performed but is performed as necessary. As illustrated in FIG. 5, the data packet DP, whose destination is the first wireless communication terminal 3A, is converted into the data frame DF having a relatively small size and is transferred to the first wireless communication terminal 3A. With this structure, the communication load on the wireless communication system 1 can be reduced.

In general, real-time communication is necessary to control an industrial equipment or others, and it is required to transmit and receive a small amount of data with small delay. In particular, there are a few hundreds or thousands of the first wireless communication terminals 3A in the factory, and a little increase of data per one terminal causes a large increase of the entire communication amount. In this preferred embodiment, the entire data amount can be reduced largely by making only a small decrease of data amount of communication for each of the first wireless communication terminals 3A by the above conversion.

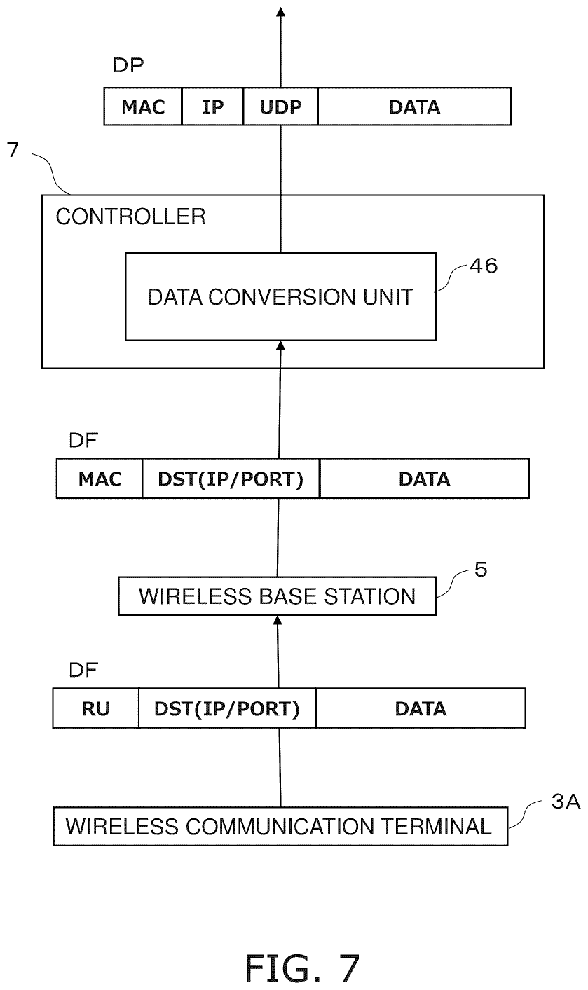

With reference to FIG. 7, upstream communication from the first wireless communication terminal 3A is described. FIG. 7 is a schematic diagram illustrating data conversion in the controller. FIG. 7 illustrates communication in which the first wireless communication terminal 3A is a source. The communication in which the wireless communication terminal is a source is referred to as “upstream communication”. In the upstream communication, the data frame DF sent from the first wireless communication terminal 3A is converted into the data packet DP as necessary.

If the destination of the data frame DF sent from the first wireless communication terminal 3A is the server 11A, the data conversion unit 46 converts the data frame DF into the data packet DP and transfers the same to the server 11A. In this way, in the upstream communication in which the first wireless communication terminal 3A is a source while the server 11A, 11B is a destination, the transfer unit 61 converts the predetermined data frame DF into the data packet DP.

Specifically, the data conversion unit 46 converts MAC/DST (IP/PORT) of the data frame DF into MAC/IP/UDP, so as to generate the data packet DP. More specifically, the data conversion unit 46 grasps the destination of the data (DATA) included in the data frame DF based on information included in the header portion of the data frame DF (MAC/DST (IP/PORT)), and generates IP/UDP of the data packet DP based on information about the grasped destination. After that, the data conversion unit 46 replaces DST (IP/PORT) of the data frame DF with the generated IP/UDP. Note that before the above process in the controller 7, the wireless base station 5 that has received the data frame DF from the first wireless communication terminal 3A replaces the RU header of the data frame DF with the MAC header.

In a case where the destination of the data frame DF sent from the first wireless communication terminal 3A is another first wireless communication terminal 3A, the transfer unit 61 transfers the data frame DF to the first wireless communication terminal 3A without converting the same. Specifically, the data frame DF is transmitted to the another first wireless communication terminal 3A via the router 13, the controller 7, the router 13, and the wireless base station 5. As described above, in a case where the destination of the data frame DF received from the first wireless communication terminal 3A is another first wireless communication terminal 3A, the controller 7 transfers the data frame DF without converting the same. In this way, processing load of the controller 7 can be reduced.

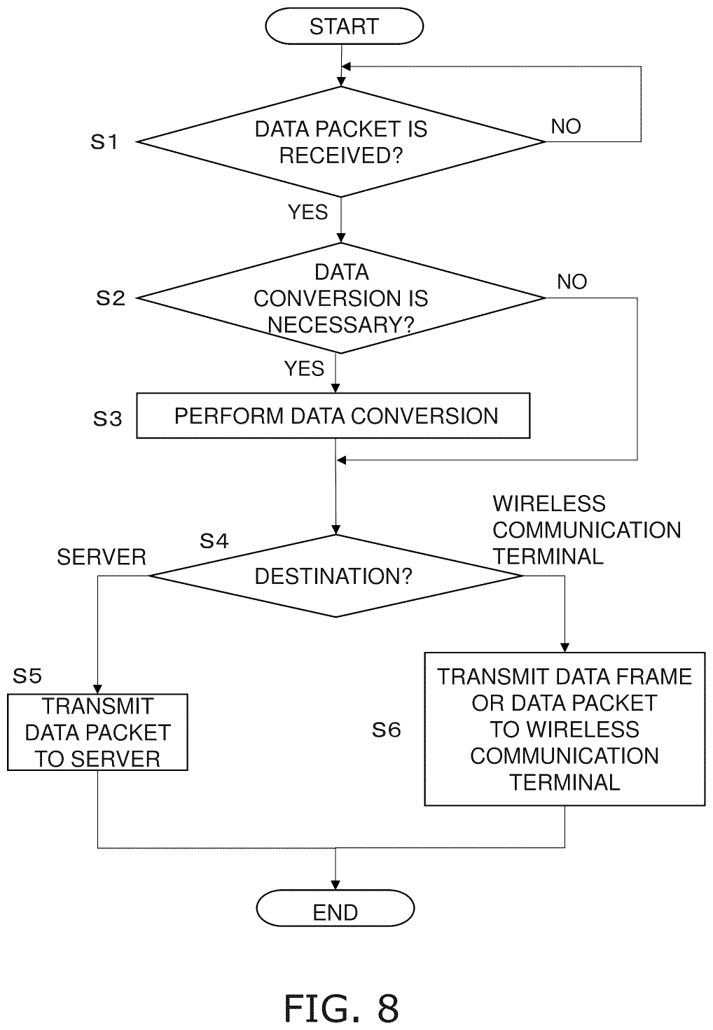

With reference to FIG. 8, data conversion control operation by the controller 7 is described. FIG. 8 is a flowchart illustrating data conversion control operation by the controller. The control flowchart described below is an example, and its steps can be omitted or exchanged as necessary. In addition, a plurality of steps may be simultaneously executed, or a portion or an entirety of steps may be executed in an overlapping manner. Furthermore, each block of the control flowchart is not always a single control operation, but can be replaced with a plurality of control operations expressed by a plurality of blocks. Note that the operations of devices are results of commands sent from the control unit to the devices, which are expressed by the steps of software application.

In Step S1, the process waits for the communication unit 44 of the controller 7 to receive the data packet DP.

In Step S2, it is determined whether or not the data conversion is necessary. Specifically, the destination determination unit 45 performs the above determination. If the data conversion is necessary, the process proceeds to Step S3. If the data conversion is not necessary, the process skips Step S3 and proceeds to Step S4. The case where the data conversion is necessary indicates a case where the destination of the data included in the data packet DP is the first wireless communication terminal 3A or the server 11A. The case where the data conversion is not necessary indicates a case where the destination of the data included in the data packet DP is the second wireless communication terminal 3B.

In Step S3, the data packet DP is converted into the predetermined data frame DF. Specifically, the data conversion unit 46 performs the above operation. The operation of converting the data packet DP into the data frame DF is already described above, and hence description thereof is omitted here.

In Step S4, the destination of the data packet DP or the data frame DF is determined. Specifically, for example, the destination determination unit 45 determines the destination of the data packet DP or the data frame DF based on information about the destination included in the data packet DP or the header portion of the data frame DF. If the destination is the server 11A, the process proceeds to Step S5. If the destination is the first wireless communication terminal 3A or the second wireless communication terminal 3B, the process proceeds to Step S6.

In Step S5, the data packet DP is transmitted to the server 11A of the destination. Specifically, the communication unit 44 performs the above operation.

In Step S6, the data frame DF or the data packet DP is transmitted to the first wireless communication terminal 3A or the second wireless communication terminal 3B of the destination. Specifically, the communication unit 44 performs the above operation.

### 2. Second Preferred Embodiment

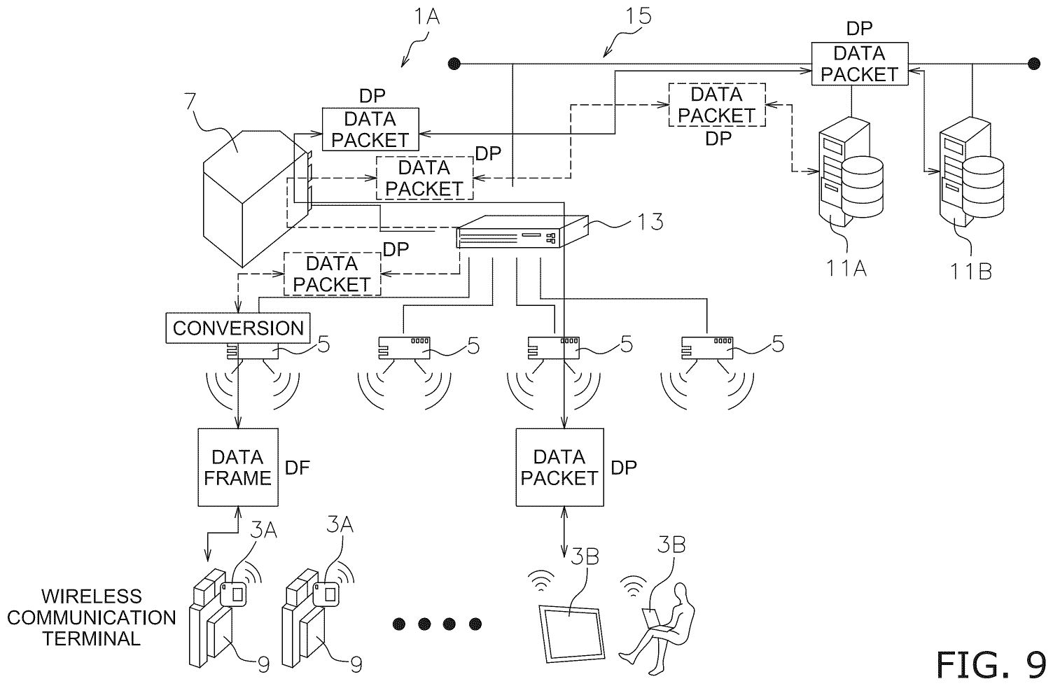

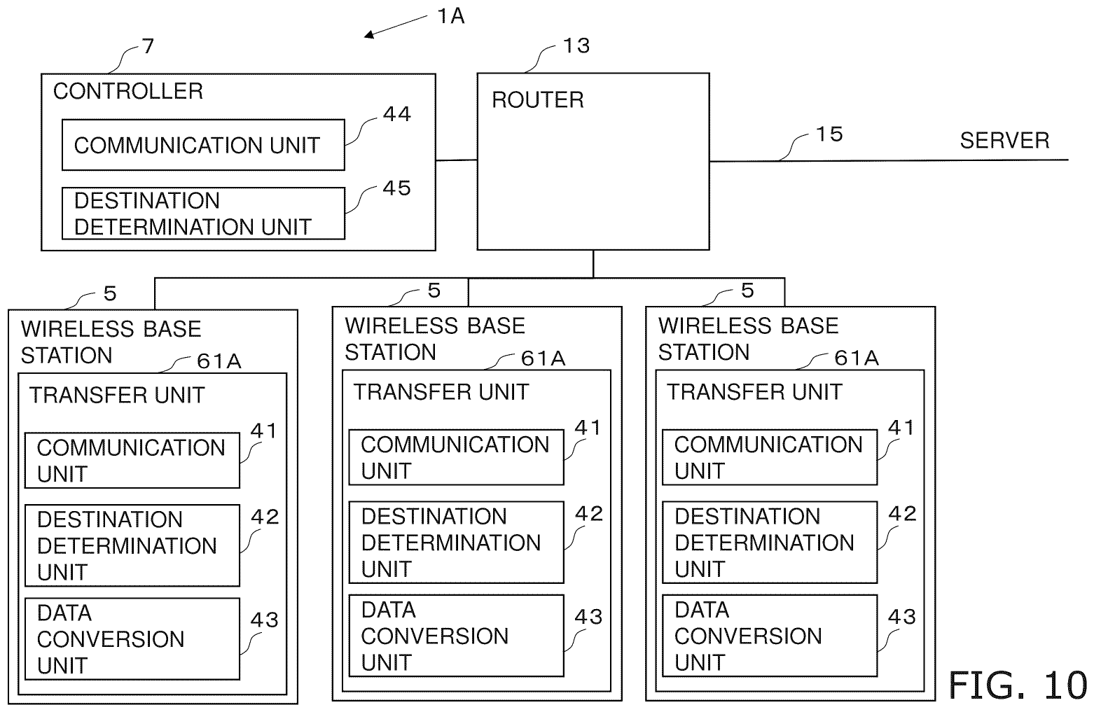

In the first preferred embodiment, the transfer unit 61 is provided to the controller 7, but the transfer unit 61 may be provided to the wireless base station 5. An example of this is described as a second preferred embodiment with reference to FIGS. 9 and 10. FIG. 9 is a schematic diagram illustrating an overall structure of the wireless communication system according to the second preferred embodiment. FIG. 10 is a block diagram illustrating a control structure of the wireless base station and the controller. Note that the basic structure and operation of the wireless communication system 1A according to the second preferred embodiment is the same as that according to the first preferred embodiment.

The wireless communication system 1A includes the plurality of first wireless communication terminals 3A, the plurality of second wireless communication terminals 3B, the plurality of wireless base stations 5, and the controller 7.

With reference to FIG. 10, the control structure of the wireless base station 5 and the controller 7 is described. FIG. 10 is a block diagram illustrating the control structure of the wireless base station and the controller. The wireless base station 5 includes the communication unit 41, the destination determination unit 42, and a data conversion unit 43. The communication unit 41, the destination determination unit 42, and the data conversion unit 43 realize a transfer unit 61A as a function that the CPU performs according to a program. The destination determination unit 42 determines the destination of the data packet DP. Based on a result of the determination by the destination determination unit 42, the communication unit 41 transfers the data packet DP as it is, or transfers the predetermined data frame DF after the data packet DP is converted into the same by the data conversion unit 43 (described later). In this way, as the plurality of wireless base stations 5 can perform the data conversion, processing load can be distributed.

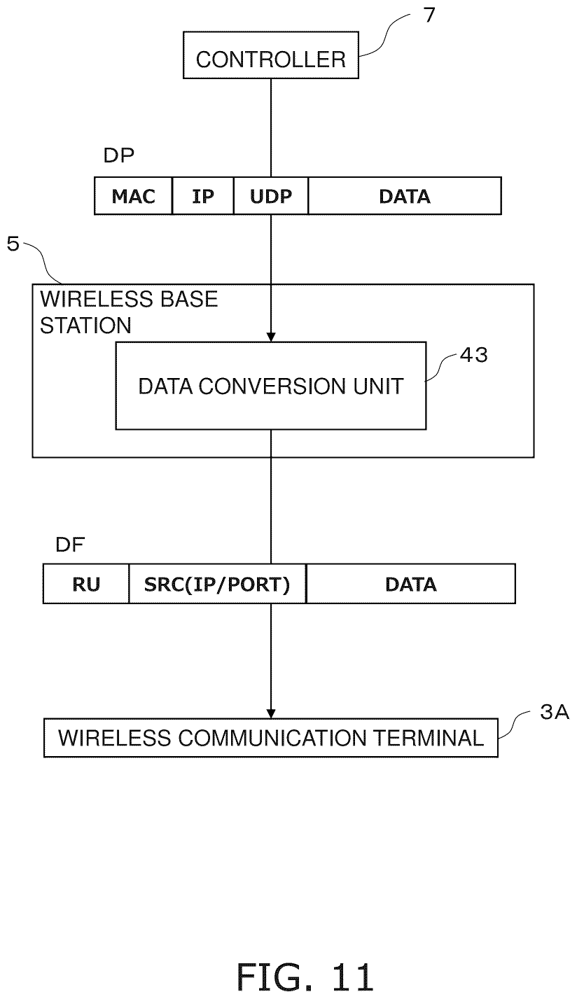

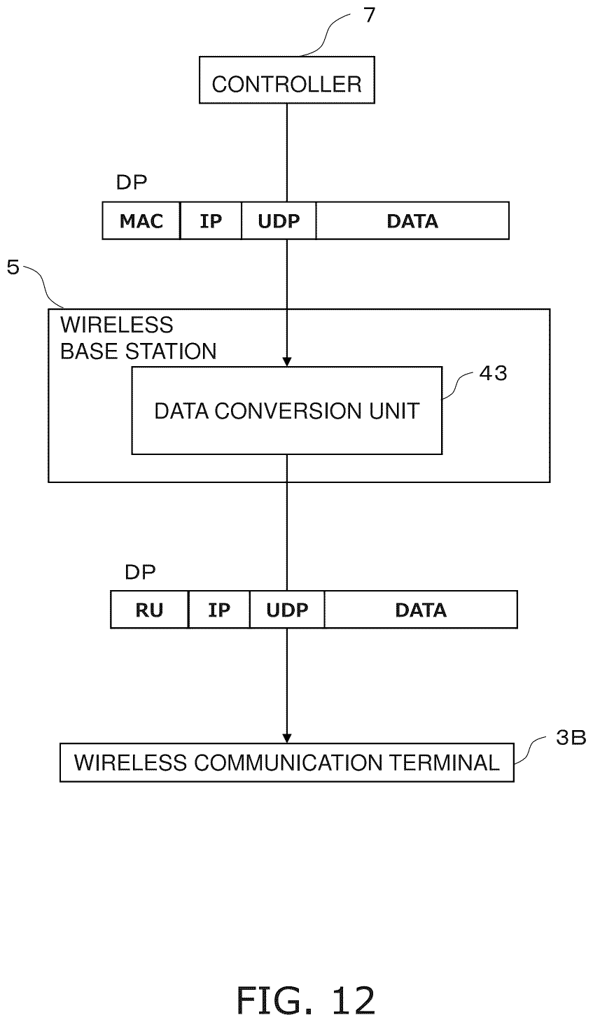

With reference to FIGS. 11 and 12, data conversion in the wireless base station 5 is described. FIGS. 11 and 12 are schematic diagrams illustrating data conversion in the wireless base station. Conventionally, in the downstream communication, the data packet DP sent from the server 11A is transmitted to the first wireless communication terminal 3A or the second wireless communication terminal 3B via the controller 7, the router 13, and the wireless base station 5. In this preferred embodiment, as described below, the data packet DP is converted into the data frame DF in some cases, and it is not converted in other cases.

The controller 7 determines one of the wireless base stations 5, whose communication range covers the first wireless communication terminal 3A or the second wireless communication terminal 3B that is the destination of the data packet DP sent from the server 11A, and sends the data packet DP to the determined wireless base station 5.

As a description in the case where the conversion is performed, as illustrated in FIG. 11, in a case where the destination of the data packet DP is one of the plurality of first wireless communication terminals 3A, the data conversion unit 43 of the wireless base station 5 converts the data packet DP into the data frame DF. Specifically, the wireless base station 5 converts the header portion (MAC/IP/UDP) of the data packet DP into RU/SRC (IP/PORT), and generates the data frame DF.

As a description in the case where the conversion is not performed, as illustrated in FIG. 12, in a case where the destination of the data packet DP is one of the plurality of second wireless communication terminals 3B, the data conversion unit 43 of the wireless base station 5 transfers the data packet DP to the second wireless communication terminal 3B without performing the conversion described above. Note that in the wireless base station 5, the MAC header of the data packet DP is replaced with the RU header.

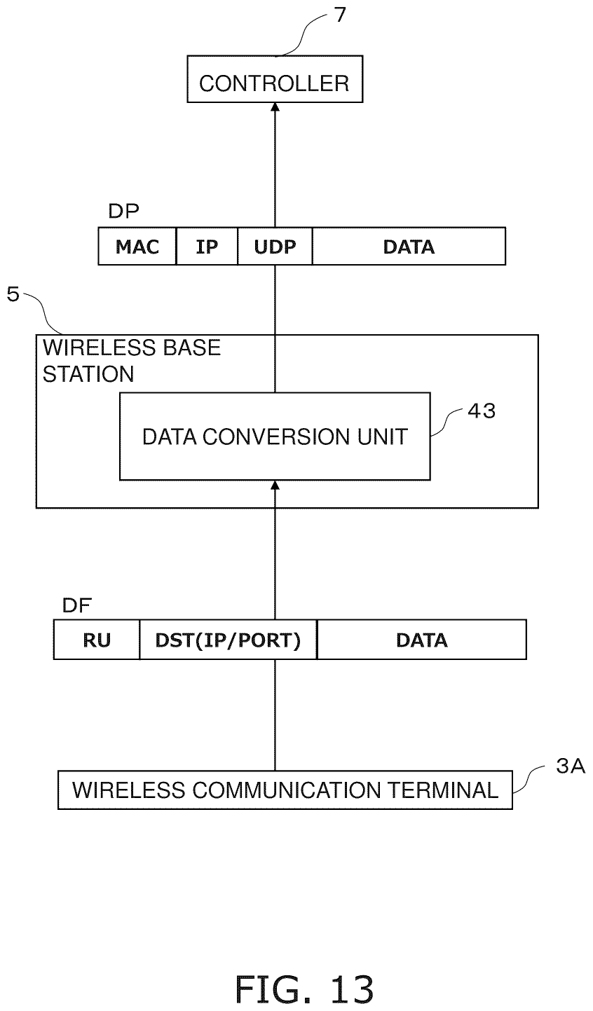

With reference to FIG. 13, the upstream communication from the first wireless communication terminal 3A is described. FIG. 13 is a schematic diagram illustrating data conversion in the wireless base station. The data conversion unit 43 of the wireless base station 5 converts the data frame DF into the data packet DP. Specifically, the header portion of the data frame DF (RU/DST (IP/PORT)) is converted into MAC/IP/UDP, and the data packet DP is generated.

As illustrated in FIG. 13, in this preferred embodiment, in a case where the destination of the data packet DP sent from the server 11A is the second wireless communication terminal 3B, the data packet DP is not converted. Therefore, processing load of converting the data packet DP is reduced as a whole. In other words, the data conversion is not always performed but is performed as necessary. The data packet DP is converted into the data frame DF having a relatively small size, and hence communication load of the wireless communication system 1A can be reduced.

### 3. Other Preferred Embodiments

Although a plurality of preferred embodiments of the present invention are described above, the present invention is not limited to the preferred embodiments described above, but can be variously modified within the scope of the invention without deviating from the spirit thereof. In particular, the plurality of preferred embodiments and variations described in this specification can be arbitrarily combined as necessary.

Preferred embodiments of the present invention are applicable to industrial equipment such as a conveyance system, but can also be applied to other devices and systems.

In order to reduce data packet size, in addition to or instead of replacement or elimination of the header as described above, it may be possible to reduce amount of data included in one packet.

Preferred embodiments of the present invention can be widely applied to wireless networks, each of which includes a plurality of wireless communication terminals, a wireless base station wirelessly connected to the wireless communication terminals, a controller that communicates to the wireless communication terminals via the wireless base station and is communicably connected to another communication system via a predetermined network.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

1-10. (canceled)

11. A wireless communication system comprising:
a plurality of wireless communication terminals;
a wireless base station wirelessly connected to the plurality of wireless communication terminals;
a controller configured or programmed to communicate to the plurality of wireless communication terminals via the wireless base station and communicably connected to another communication system via a predetermined network; and
a transfer processor configured or programmed to:
in a case where a destination of a data packet sent from the another communication system is a specific wireless communication terminal among the plurality of wireless communication terminals, convert the data packet into a predetermined data frame and transfer the predetermined data frame to the wireless communication terminal; and
in a case where the destination of the data packet sent from the another communication system is a wireless communication terminal other than the specific wireless communication terminal among the plurality of wireless communication terminals, transfer the data packet to the wireless communication terminal without converting the data packet into the predetermined data frame;
the wireless communication system further comprises a plurality of the specific wireless communication terminals; and
in a case where a destination of a predetermined data frame sent from one of the plurality of specific wireless communication terminals is another of the plurality of specific wireless communication terminals, the transfer processor is configured or programmed to transfer the predetermined data frame to the wireless communication terminal without converting the predetermined data frame into the data packet.

12. The wireless communication system according to claim 11, wherein, in a case where a destination of a predetermined data frame sent from a specific wireless communication terminal is another communication system, the transfer processor is configured or programmed to convert the predetermined data frame into the data packet and transfer the data packet to the another communication system.

13. The wireless communication system according to claim 11, wherein the transfer processor is included in the controller.

14. The wireless communication system according to claim 11, wherein the transfer processor is included in the wireless base station.

15. The wireless communication system according to claim 11, wherein
the data frame includes at least a destination and a transmission data portion; and
the data packet is a communication packet of a versatile communication protocol format that is transferred on the Ethernet.

16. The wireless communication system according to claim 11, wherein at least one of the plurality of wireless communication terminals is mounted in a mobile body.

17. A controller in a wireless communication system including a plurality of wireless communication terminals, and a wireless base station wirelessly connected to the wireless communication terminals, the controller being configured or programmed to communicate to the plurality of wireless communication terminals via the wireless base station and being communicably connected to another communication system via a predetermined network, the controller comprising:
a transfer processor configured or programmed to:
in a case where a destination of a data packet sent from the another communication system is a specific wireless communication terminal among the plurality of wireless communication terminals, convert the data packet into a predetermined data frame and transfer the predetermined data frame to the wireless communication terminal; and
in a case where the destination of the data packet sent from the another communication system is a wireless communication terminal other than the specific wireless communication terminal among the plurality of wireless communication terminals, transfer the data packet to the wireless communication terminal without converting the data packet into the predetermined data frame;
the wireless communication system further comprises a plurality of the specific wireless communication terminals; and
in a case where a destination of a predetermined data frame sent from one of the plurality of specific wireless communication terminals is another of the plurality of specific wireless communication terminals, the transfer processor is configured or programmed to transfer the predetermined data frame to the wireless communication terminal without converting the predetermined data frame into the data packet.

18. A wireless base station in a wireless communication system including a plurality of wireless communication terminals and a controller communicably connected to another communication system via a predetermined network, the wireless base station being wirelessly connected to the wireless communication terminals and being connected to the controller, the wireless base station comprising:
a transfer processor configured or programmed to:
in a case where a destination of a data packet sent from the another communication system is a specific wireless communication terminal among the plurality of wireless communication terminals, convert the data packet into a predetermined data frame and transfer the predetermined data frame to the wireless communication terminal; and
in a case where the destination of the data packet sent from the another communication system is a wireless communication terminal other than the specific wireless communication terminal among the plurality of wireless communication terminals, transfer the data packet to the wireless communication terminal without converting the data packet into the predetermined data frame;
the wireless communication system further comprises a plurality of the specific wireless communication terminals; and
in a case where a destination of a predetermined data frame sent from one of the plurality of specific wireless communication terminals is another of the plurality of specific wireless communication terminals, the transfer processor is configured or programmed to transfer the predetermined data frame to the wireless communication terminal without converting the predetermined data frame into the data packet.

19. A data packet transfer method in a wireless communication system including a plurality of wireless communication terminals, a wireless base station wirelessly connected to the wireless communication terminals, and a controller configured or programmed to communicate to the wireless communication terminals via the wireless base station and to be communicably connected to another communication system via a predetermined network, the method comprising:
determining whether or not a destination of a data packet sent from the another communication system is a specific wireless communication terminal among the plurality of wireless communication terminals;
converting the data packet into a predetermined data frame in a case where the destination is the specific wireless communication terminal, and not converting the data packet in a case where the destination is a wireless communication terminal other than the specific wireless communication terminal;
transferring the predetermined data frame or the data packet to the wireless communication terminal;
the wireless communication system comprises a plurality of the specific wireless communication terminals; and
in a case where a destination of a predetermined data frame sent from one of the plurality of specific wireless communication terminals is another of the plurality of specific wireless communication terminals, transferring the predetermined data frame to the wireless communication terminal without converting the predetermined data frame into the data packet.
